(19) United States
(12) Patent Application Publication
(10) Pub. No.: US 2021/0256954 A1
(43) Pub. Date: Aug. 19, 2021

(54) CANCELLATION OF SOUND AT FIRST DEVICE BASED ON NOISE CANCELLATION SIGNALS RECEIVED FROM SECOND DEVICE

(71) Applicant: Lenovo (Singapore) Pte. Ltd., Singapore (SG)

(72) Inventors: Scott Wentao Li, Cary, NC (US); Igor Stolbikov, Apex, NC (US)

(21) Appl. No.: 16/793,640

(22) Filed: Feb. 18, 2020

(51) Int. Cl. G10K 11/178

(52) U.S. Cl. CPC G10K 11/17857; G10K 11/17873; G01S 19/03; G10K 2210/1081; G10K 2210/3219

(57) ABSTRACT

In one aspect, a first device may include at least one processor and storage accessible to the at least one processor. The storage may include instructions executable by the at least one processor to establish a peer to peer network between the first device and a second device. The instructions may also be executable to select the first device to generate noise cancellation signals based on the first device being closer to a source of sound than the second device. The instructions may be further executable to use the first device to generate the noise cancellation signals based on sound from the source of sound, and to transmit the noise cancellation signals over the peer to peer network to the second device.

### FIELD

The present application relates to technically inventive, non-routine solutions that are necessarily rooted in computer technology and that produce concrete technical improvements.

### BACKGROUND

Open-office layouts are gaining popularity. But as recognized herein, because of the lack of separate offices with walls to block sound in these types of layouts, speech between various people or the speech of a person conducting a telephone call can be heard by others within the open-office environment. This speech can be difficult to ignore and can contribute to a decline in productivity.

As also recognized herein, current noise cancellation headphones that a person might wear to cancel ambient noise and concentrate better on his/her work are inadequate for cancelling speech. This is because, as recognized herein, the inflections in the speech might change too fast for the person's noise cancellation headphones to keep up, resulting in the speech itself being heard by the person before the anti-noise from noise cancellation is presented to the person's ears. Thus, the present application recognizes that such headphones do not have enough time to react to sound changes in the speech to generate different anti-noises before the sound changes themselves hit the eardrums of the person.

There are currently no adequate solutions to the foregoing computer-related, technological problem.

### SUMMARY

Accordingly, in one aspect a first device includes at least one processor, a microphone accessible to the at least one processor, and storage accessible to the at least one processor. The storage includes instructions executable by the at least one processor to detect a first discrete sound based on input from the microphone, identify a first time at which the input from the microphone is received, and receive an indication from a second device that indicates a second time at which the first discrete sound was detected by the second device. The instructions are also executable to determine which of the first time and the second time is earlier. Based on the first time being earlier than the second time, the instructions are executable to select the first device for performance of noise cancellation and to transmit noise cancellation signals to the second device based on additional discrete sounds that are detected by the first device. Based on the second time being earlier than the first time, the instructions are executable to select the second device for performance of noise cancellation and to receive noise cancellation signals from the second device based on additional discrete sounds that are detected by the second device.

Thus, in some examples the instructions may be executable by the at least one processor to determine that the first time is earlier than the second time and to transmit, to the second device and based on the determination that the first time is earlier than the second time, respective noise cancellation signals generated based on respective additional discrete sounds that are detected by the at least one microphone on the first device. In some embodiments, the first device may include a digital signal processor (DSP) and the respective noise cancellation signals may be generated using the DSP prior to transmission of the respective noise cancellation signals to the second device.

Additionally, if desired the instructions may be executable to determine an offset for respective times at which the same discrete sound reaches the first and second devices based on the first and second times. The instructions may then be executable to transmit, to the second device and based on the offset, one or more indications regarding respective times at which respective audio generated from respective noise cancellation signals received from the first device should be presented at the second device to cancel respective discrete sounds that reach the second device.

Also in some examples, the instructions may be executable to determine that the second time is earlier than the first time and to receive, from the second device and based on the determination that the second time is earlier than the first time, respective noise cancellation signals generated based on respective additional discrete sounds that are detected by at least one microphone on the second device. Additionally, if desired the instructions may be executable to determine an offset for respective times at which the same discrete sound reaches the first and second devices based on the first and second times. The instructions may then be executable to use the offset to present, using the first device and based on receipt of one or more indications from the second device of respective times that respective discrete sounds reached the second device, respective audio generated from the respective noise cancellation signals to cancel the respective discrete sounds as the respective discrete sounds reach the first device.

Thus, in some implementations the first device may include at least one speaker accessible to the at least one processor and the instructions may be executable to present, via the at least one speaker, the respective audio generated from the respective noise cancellation signals. Also in some implementations, the first device may include a digital signal processor (DSP) and the respective audio may be presented at least in part by processing the respective noise cancellation signals using the DSP.

Also, note that the first and second devices may communicate with each other peer to peer.

In another aspect, a method includes establishing a peer to peer network between at least first and second devices, electing one of the first and second devices for generating noise cancellation signals based on which of the first and second devices is closest to a source of sound, using the elected device to generate the noise cancellation signals based on sound detected by the elected device, and transmitting the noise cancellation signals over the peer to peer network to the non-elected device.

In some examples, the method may include determining which of the first and second devices is closest to a source of sound by identifying a current location of the source of sound and identifying the current locations of the first and second devices. The current locations of the first and second devices may be determined based on global positioning system (GPS) coordinates for the respective first and second devices, while the current location of the source of sound may be determined based on input from a camera.

Also in some examples, the method may include determining which of the first and second devices is closest to a source of sound based on which of the first and second devices is the first one to detect a first discrete sound from the source.

Additionally, in some implementations the method may include electing the first device for generating noise cancellation signals based on the first device being closest to the source of sound, using the first device to generate noise cancellation signals based on sound detected by the first device, and transmitting the noise cancellation signals peer to peer to the second device. Accordingly, in certain examples the method may include using the first device to facilitate a telephone call, using the first device to provide input to a microphone as part of the telephone call to another device, and also using the input to the microphone to generate the noise cancellation signals.

Still further, in some implementations the method may include establishing the peer to peer network between the first device, the second device, and a third device, and then electing one of the first, second, and third devices for generating noise cancellation signals based on which of the first, second, and third devices is closest to the source of sound. The method may then include using the elected device to generate noise cancellation signals based on sound detected by the elected device, and transmitting the noise cancellation signals over the peer to peer network to the plural non-elected devices.

Also in some implementations, the method may include electing the first device for generating first noise cancellation signals based on the first device being closest to a first source of sound, and using the first device to generate the first noise cancellation signals based on sound that is detected by the first device from the first source of sound. The method may also include transmitting the first noise cancellation signals over the peer to peer network to the second device. In these implementations, the method may further include electing the second device for generating second noise cancellation signals based on the second device being closest to a second source of sound different from the first source of sound, where the first and second sources of sound may emit sound concurrently. The method may then include receiving, from the second device, the second noise cancellation signals and using the second noise cancellation signals to cancel sound from the second source of sound.

Even further, in some implementations the method may include electing at a first time the first device for generating first noise cancellation signals based on the first device being closest to a source of sound, using the first device to generate the first noise cancellation signals based on sound detected by the first device from the source of sound, and transmitting the first noise cancellation signals over the peer to peer network to the second device. In these implementations, the method may then include electing at a second time later than the first time the second device for generating second noise cancellation signals based on the second device being closest to the same source of sound and then receiving, from the second device, the second noise cancellation signals generated based on sound detected by the second device from the same source of sound.

In another aspect, at least one computer readable storage medium (CRSM) that is not a transitory signal includes instructions executable by at least one processor to select a first device to generate first noise cancellation signals based on the first device being closer to a first source of sound than a second device, where the first and second devices communicate with each other over a network. The instructions are also executable to use the first device to generate the first noise cancellation signals based on sound from the first source of sound and to transmit the first noise cancellation signals over the network to the second device.

In some implementations, the instructions may be executable to determine the first device as being closer to the first source of sound based on the first device being the first one of the first and second devices to detect a first discrete sound from the first source of sound.

Also in some implementations, the instructions may be executable to select the second device to generate second noise cancellation signals based on the second device being closer to a second source of sound than the first device, where the second source of sound may be different from the first source of sound but emits sound concurrently with the first source of sound emitting sound. The instructions may also be executable to receive, from the second device over the network, the second noise cancellation signals and to present audio at the first device to cancel discrete sounds from the second source of sound based on receipt of the second noise cancellation signals.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3-5 are schematic diagrams illustrating present principles for various sources of sound;

FIG. 6 is a flow chart of an example algorithm consistent with present principles; and

FIG. 7 is an example graphical user interface (GUI) for configuring one or more settings of a device operating consistent with present principles.

### DETAILED DESCRIPTION

Among other things, the present application discloses using a dynamic peer to peer network of headsets/devices with similar noise canceling capability (e.g., similar or the same microphones, speakers, digital signal processors, sufficient CPU cycles, etc.) in order to use one device to help cancel noise at other devices. This may be done using time of flight values for noise from a noise source to reach each of the devices. The shortest/smallest time of flight value may be used to then elect the peer device that is closest to the sound source for that device to then generate anti-noise wave forms to cancel sound it detects. The wave forms may then be broadcasted from that peer device to many other peers in the network and may be used by those other peers to cancel the same sound by the time it reaches the other peer devices since wireless signals can travel faster than sound and hence give the other peer devices time to receive the wave form and react by presenting the anti-noise. Thus, other peer devices on the network (other than the closest device to the source of sound) may “peek” into the future in terms of what sound is coming toward them so that those devices can cancel the sound at the appropriate time owing to the longer time window to process and generate the anti-wave sound.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C# or C++, and can be stored on or transmitted from a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

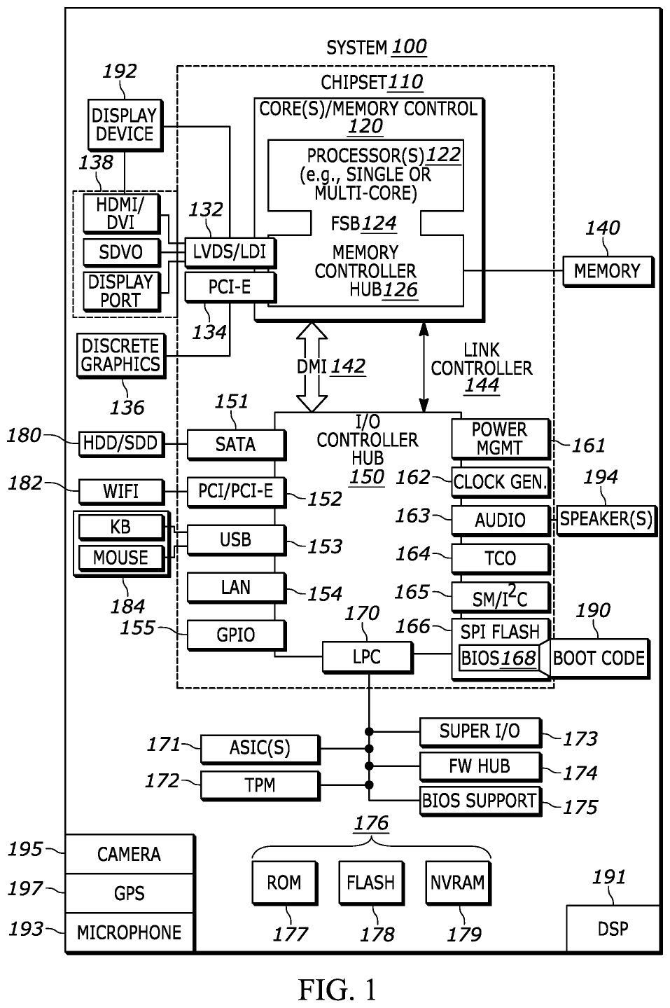

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core central processing units (CPUs), etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio consistent with present principles), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, in some examples the system 100 may include a digital signal processor (DSP) 191. The DSP 191 may be used for receiving input from a microphone and executing an acoustic noise cancellation algorithm to generate noise cancellation signals that may be used by the system 100 (and other devices) to present audio via speakers to cancel the noise detected by the microphone so that a user cannot hear the noise. The DSP 191 may also be used for processing noise cancellation signals received from other devices to present audio via the speakers to cancel noise that reaches the system 100 so that the user cannot hear the noise. Notwithstanding the foregoing, also note that in some embodiments a CPU in the system 100 (rather than the DSP 191) may similarly execute an acoustic noise cancellation algorithm and process noise cancellation signals received from other devices.

As also shown in FIG. 1, the system 100 may also include an audio receiver/microphone 193 that provides input from the microphone 193 to the processor 122 and/or DSP 191 based on audio that is detected. The system 100 may also include a camera 195 that gathers one or more images and provides input related thereto to the processor 122. The camera 195 may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video.

Still further, the system 100 may include a global positioning system (GPS) transceiver 197 that is configured to communicate with at least one satellite to receive/identify geographic position information and provide the geographic position information to the processor 122 consistent with present principles. However, it is to be understood that another suitable position receiver other than a GPS receiver may be used in accordance with present principles to determine the location of the system 100.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122.

It is to be understood that an example client device or other machine/computer may include fewer or more features than shown on the system 100 of FIG. 1. In any case, it is to be understood at least based on the foregoing that the system 100 is configured to undertake present principles.

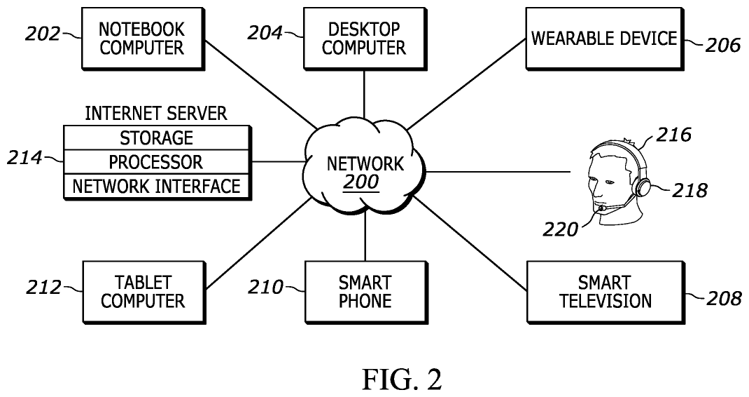

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a Bluetooth headset 216 and a server 214 such as an Internet server that may provide cloud storage accessible to the devices 202-212, 216. It is to be understood that the devices 202-216 may be configured to communicate with each other over the network 200 to undertake present principles.

Describing the headset 216 in more detail, it is shown from a side elevational view and may be engaged with a person's left and right ears so that respective left and right speakers 218 abut the ears in order to present audio to cancel sound from another sound source. The headset 216 may also include a microphone 220 that may be positioned adjacent to the person's mouth. Thus, the speakers 218 may also be used for hearing audio of a VoIP or other type of telephone call while a user speaks into the microphone 220 as part of the call consistent with present principles.

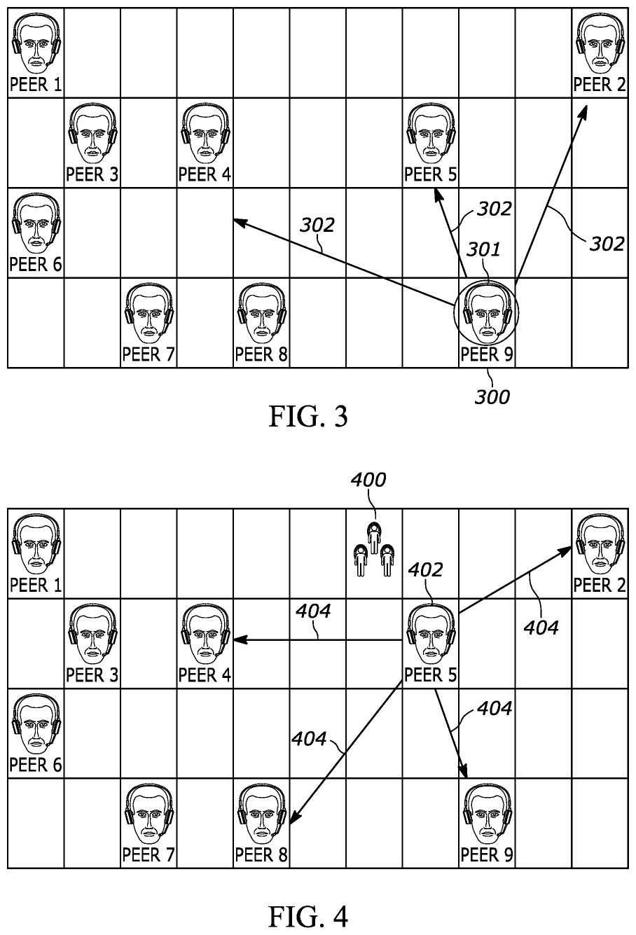

FIGS. 3-5 show schematic diagrams of various examples for cancelling noise from a source of sound consistent with present principles. Beginning first with FIG. 3, it shows nine respective users wearing their own respective peer headsets while they each sit in their own respective cubicle in an open-office environment in which sound can easily travel between cubicles. As shown, each peer headset is disposed over top of the respective user's head so that left and right speakers of the respective headset abut respective left and right ears of the respective user.

Additionally, note that the peer headsets may be communicating directly with each other over a network, peer to peer, without communications between any two peer devices being routed through another device such as a server. The peer to peer network communication may be established by, for example, peer to peer Bluetooth communication (e.g., Bluetooth 5.0) using respective Bluetooth transceivers on the peer devices, or peer to peer Wi-Fi direct communication using respective Wi-Fi transceivers on the peer devices. In some examples, the peer to peer network may be dynamically formed and maintained in that devices may come online onto the network as they come within signal range of other peer devices and/or as they are powered on to then begin communicating peer to peer.

Furthermore, also note that each of the peer headsets in the example shown may have similar microphones, left and right speakers, DSPs, and CPUs. Further note that in this example each of the peer headsets are assumed to remain in more or less the same location (e.g., each user remains seated in his or her respective cubicle while wearing the respective peer device).

As shown in FIG. 3, a user 300 designated as “peer 9” is engaging in a telephone conference call with other people not shown in FIG. 3 using his/her peer device 301. However, sound from the user 300 speaking as part of the conference call may still travel to the other respective users shown in FIG. 3, resulting in those other users hearing the user 300 speaking.

Accordingly, owing to the dynamic peer to peer network being formed based on the devices that are currently online and within proximity to each other to transmit wireless communications peer to peer, and owing to the user 300 being engaged in a loud conference call, the peer devices on the peer to peer network as shown in FIG. 3 may determine which peer device/peer device's microphone is closest to the sound source based on time of flight of the sound. So, for example, each peer device may report to the other peer devices on the network a time at which its microphone detected a first discrete sound from the sound source, with the first discrete sound itself also being identified in the report. Additionally, each peer device may report the detected amplitude of the sound wave for the first discrete sound as detected at the respective peer device, and/or report the detected volume level of the first discrete sound. Thus, whichever peer device detected the first discrete sound first in time may be determined to be the closest peer to the source of sound based on the first discrete sound's time of flight to that peer device being the fastest.

Note that the discrete sound itself may be established by a particular word, or even a particular discrete syllable of a word or an individual phoneme that is spoken. The discrete sound may also be established by a word, syllable, or phoneme that is sung rather than spoken. Also note that the discrete sound may be identified using voice recognition software, such as voice recognition software used as part of a digital assistant like Apple's Siri, Google's Assistant, or Amazon's Alexa.

In any case, according to the example shown in FIG. 3, the peer device 301 that is facilitating the conference call for the user 300 is also the closest peer device to the source of sound (the user 300). One or more (e.g., all) peer devices may therefore elect the peer device 301. Based on the peer device 301 being elected, the DSP in the device 301 may be used to process sound detected at that device's microphone (as might also be used for facilitating the call itself) and to execute an acoustic noise cancellation algorithm to generate the anti-wave/noise cancellation signals for each discrete sound that is detected by the device 301. Those signals may then be transmitted to the other peer devices using the CPU and network transceiver in the device 301.

Furthermore, note that the peer device 301 may also transmit data over the peer to peer network for each respective noise cancellation signal being transmitted that indicates a time at which the corresponding discrete sound to be cancelled was detected by the peer device 301. The peer device 301 may also transmit data indicating the amplitude/volume level of the discrete sound itself as detected at the device 301.

This time at which the corresponding discrete sound was detected by the device 301, along with a time offset determined by the peer device 301 or the other peer device that receives the noise cancellation signal, may then be used to compute a later time at which audio generated from the respective noise cancellation signal should be presented using the speakers of the other peer device to cancel the same sound at the time it reaches the other peer device. The offset itself may be determined, for example, based on the initial time of flight data that was exchanged between the devices so that a time difference can be computed by subtracting the time at which the peer device 301 detected the first discrete sound from the time at which the other peer device itself detected the same first discrete sound. Additionally, a difference in reported amplitudes or volume levels at which the first discrete sound was detected by the peer device 301 and by the other respective peer device may be used to match the amplitude/volume level of the audio for noise cancellation that is produced at the other peer device's speakers to the amplitude/volume level of the corresponding sound itself at the point it reaches that peer device.

As shown in FIG. 3, the noise cancellation signals and/or additional data being transmitted by the peer device 301 is illustrated in FIG. 3 via the arrows 302.

Thus, all other peer devices may receive the anti-wave from the peer device 301 and based on the initial time of flight information the peer devices may then compute the time shift and amplitude of the anti-wave itself that is to be sent to that peer device's speakers for presentation to cancel sound (e.g., speech) from the source (the user 300). Thus, owing to wireless signals being transmitted faster than the speed of sound itself, the peer device 301 may be used to generate a noise cancellation signal for a particular sound so that this sound may be cancelled by the other peer devices shown in FIG. 3 at respective times the same sound reaches each other peer device.

Now describing FIG. 4, another example consistent with present principles is shown. In this case, a loud conversation between people 400 is occurring, with none of the people 400 wearing a peer device or having any other device on their person to generate noise cancellation signals like in the example above. However, sound from their conversation is still reaching the other users shown in FIG. 4 owing to their open-office layout.

Accordingly, consistent with present principles a dynamic peer to peer network may be formed/established. Peer devices on the network may then determine which microphone/peer device is closest to the sound source 400 based on time of flight as disclosed herein. In this example, the peer device 402 for “Peer 5” is determined to the closest to the source of sound 400.

Based on the device 402 being the closest device with a microphone to the source of sound 400, the device 402 may be elected to process sound from the source 400 and transmit corresponding noise cancellation signals to other peer devices via peer to peer communication.

The other peer devices may then receive the noise cancellation signals from the device 402 (as illustrated by the arrows 404). Then based on the initial time of flight information, the peer devices may compute their own respective time shifts for when the noise cancellation signals should be presented. Those peer devices may each also compute the amplitude at which anti-wave sound should be presented at that peer device's speakers to match the amplitude of the sound wave at the point it reaches the respective peer device. Thus, sound from the people 400 may be canceled at each peer device via its respective speakers.

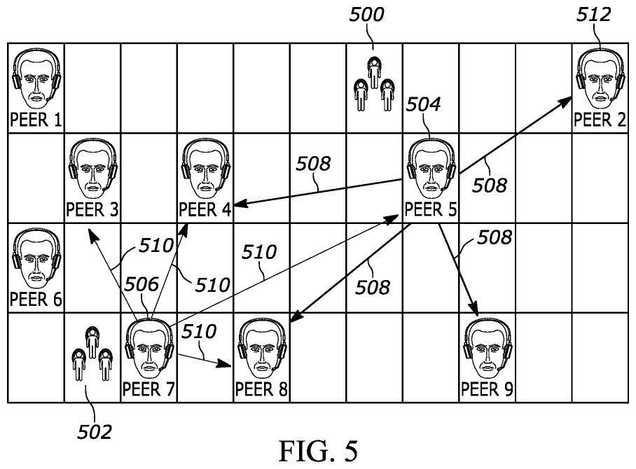

FIG. 5 shows still another example. In FIG. 5, multiple loud conversations between different groups of people 500, 502 are ongoing at different locations within the open-office environment. The conversations 500, 502 may be concurrently ongoing at the same time as each other, and therefore a different peer device may be the closest to each one.

Thus, a dynamic peer to peer network may be formed and then peers on the network may determine which microphone/peer device is closest to each sound source based which peer device receives a particular discrete sound first. In this case, peer device 504 is determined to be closest to the source of sound 500, while peer device 506 is determined to be closest to the source of sound 502. Note that sound source processing and/or sound separation using audio signal processing software may be used to help separate and identify respective discrete sounds from each source 500, 502 to determine which device is closest to which source of sound.

Then, based on the device 504 being selected to process sound from the source 500 and to transmit corresponding noise cancellation signals to the other peer devices, the device 504 may begin doing so and transmit the noise cancellation signals to the other devices, peer to peer, as illustrated by the arrows 508. Furthermore, based on the device 506 being selected to process sound from the source 502 and to transmit corresponding noise cancellation signals to the other peer devices, the device 506 may begin doing so and transmit the noise cancellation signals to the other devices, peer to peer, as illustrated by the arrows 510.

Accordingly, all other peers may receive the anti-wave/noise cancellation signals from both of the devices 504, 506, while each of the devices 504, 506 may also receive anti-wave/noise cancellation signals from the other one of the devices 504, 506. Each peer device may then, based on the initial time of flight information, compute its own respective time shifts for when the respective noise cancellation signals that are received should be presented at that respective device. Each peer device may also compute the amplitudes at which the respective anti-wave sounds should be presented at that peer device's speakers to match the amplitudes of the respective sound waves at the point they reach the respective peer device. Thus, sound from the sources 500, 502 may be canceled at each peer device (via its respective speakers) other than the respective peer device that is the closest to the respective source 500 or 502.

In a variation on the example immediately above, suppose one of the sources of sound 500, 502 changes location and/or that one of the peer devices 504, 506 changes locations. In one or both of those circumstances, the peer devices on the peer to peer network may elect handoffs of which device is to generate and transmit noise cancellation signals based on whichever peer device is determined to be closest to the source of sound at a particular time. So, for example, if the source of sound 500 moves toward “Peer 2” in FIG. 5, when the source 500 becomes nearer to the device 512 than to the device 504, peer device 504 may hand off to peer device 512 responsibility to generate and transmit noise cancellation signals for the source 500. Other peer devices (including the device 504) may then use the noise cancellation signals as received from the device 512 to cancel sound from the source 500.

Thus, it is to be understood consistent with present principles that some or all of the peer devices currently on the dynamic peer to peer network may continually or periodically (e.g., every half-second) exchange time of flight information for when various discrete sounds are detected by their respective microphones (e.g., exchange always, exchange periodically responsive to detection of the initial and/or continued movement of the sound source 500, etc.). Each peer device may also continually or periodically compute its new time offset to use (e.g., based on the initial and/or continued movement of the sound source 500 with respect to that peer device). In some embodiments, each peer device may also continually or periodically update the other peer devices that are online on its new time offset as well as the time offsets for any other peer devices that it might have computed.

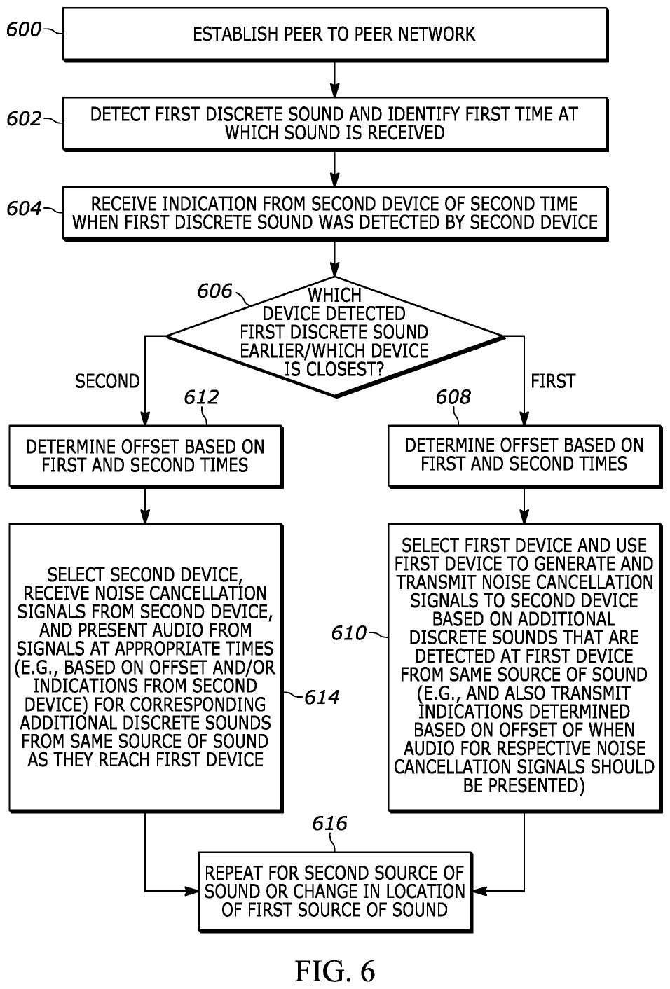

Continuing the detailed description in reference to FIG. 6, it shows example logic that may be executed by a first peer device and/or the system 100 consistent with present principles. Beginning at block 600, the first device may establish a peer to peer network with at least one other device by, e.g., communicating wirelessly directly with the other device without communications being routed through a server, router, access point, etc. From block 600 the logic may proceed to block 602.

At block 602 the first device may detect a first discrete sound and identify a first time of day at which the sound was received. The time of day may be determined not just in terms of hour, minutes, and seconds, but also in terms of milliseconds in some examples. The time of day may be identified, for example, from a clock application executing at the first device.

From block 602 the logic may then proceed to block 604. At block 604 the first device may receive an indication from the other peer device (referenced as the “second device” below) of a second time of day at which the second device detected the same first discrete sound. From block 604 the logic may then proceed to decision diamond 606.

At diamond 606 the first device may determine, based on the first and second times of day, which of the first and second devices detected the first discrete sound earlier. Additionally or alternatively, at diamond 606 the first device may use other ways to determine which of the first and second device is closer to the source of sound that emitted the first discrete sound.

For example, one other way may include the first device determining which of the first and second devices is closest to a source of sound by identifying a current location of the source of sound using a camera and object recognition to identify, from a camera image, people talking or an inanimate object capable of producing sound. The current locations of the first and second devices may then be identified, e.g., also using images from the camera and/or using GPS coordinates reported by respective GPS transceivers on each device. Additionally or alternatively, if one of the first and second devices is currently facilitating a telephone call, then the source of sound itself may be determined to be the location of the device facilitating the telephone call, e.g., as expressed in GPS coordinates.

Then based on knowing the locations of the first and second devices and knowing the location of the source of sound itself, which of the first and second devices is closest to the source of sound may be determined at diamond 606.

In any case, however the closer device is determined, responsive to a determination at diamond 606 that first device is closest to the source of sound, the logic may proceed to block 608. But responsive to a determination at diamond 606 that the second device is closest to the source of sound, the logic may proceed to block 612. Then at either of blocks 608 or 612 a time offset may be determined as the difference between the first and second times of day. Note that the time offset may be expressed as a positive number that indicates the additional amount of time it takes for sound to travel from the source of sound to the farther device than to the closer device.

However, note that the time offset may be determined still other ways besides using the first and second times of day. For example, based on knowing the locations of the first and second devices, knowing the location of the source of sound itself, and assuming certain speed of sound in dry air (e.g., 343 meters per second at 20 degrees Celsius), the time offset for determining when noise cancellation signals should be presented at the relatively farther device may be calculated as the difference between the time for sound to travel from the source to the farther device and the time for sound to travel from the source to the nearer device.

From block 608 the logic may then proceed to block 610. At block 610 the first device may be selected/elected, and then used to generate and transmit noise cancellation signals to the second device based on additional discrete sounds that are detected at the first device after the first discrete sound but from the same source of sound.

Also at block 610, in some examples the first device may also transmit indications, determined based on the time offset, of when audio generated from the respective noise cancellation signals that are being transmitted should be presented at the second device. However, in other examples the second device itself may compute the time offset and/or determine when audio generated from the respective noise cancellation signals it receives should be presented at the second device.

Referring back to block 612, after the time offset is determined at block 612 note that the logic may proceed to block 614. At block 614 the second device may be selected/elected. Also at block 614, the first device may receive noise cancellation signals from the second device based on additional discrete sounds that are detected at the second device after the first discrete sound but from the same source of sound.

Then the first device may, also at block 614, use its DSP to process the noise cancellation signals. The first device may then use left and right ear speakers on or in communication with the first device to present audio generated from the received noise cancellation signals at appropriate times. Each appropriate time may be determined based on an indication from the second device that is received at the first device (similar to as set forth two paragraphs above) and/or based on the first device itself calculating when a corresponding discrete sound from the source will reach the first device as disclosed herein (e.g., using a time offset and the time of day at which the second device detected the corresponding discrete sound from the source).

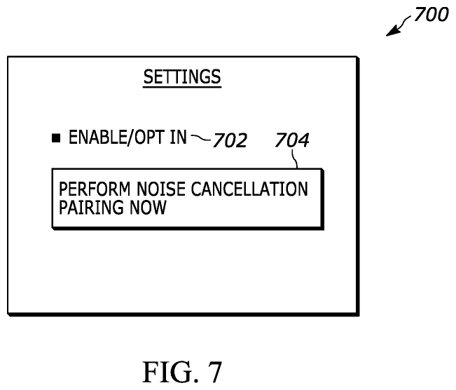

Now describing FIG. 7, it shows an example graphical user interface (GUI) 700 that may be presented on the display of a device configured to undertake present principles in order to configure one or more settings of the device. Thus, as shown the GUI 700 may include an option 702 that may be selectable by directing cursor or touch input to the adjacent check box in order to set or configure the device to undertake present principles. For example, selection of the option 702 may enable the device to undertake operations discussed above in reference to FIGS. 3-5 and to execute the logic of FIG. 6.

The GUI 700 may also include a selector 704 that may be selectable based on touch or cursor input to initiate a process for pairing the device with other peer devices for noise cancellation consistent with present principles. Thus, for example, the selector 704 may be selectable to begin a process whereby potential peer devices are discovered and the user provides authorization for his/her device to communicate peer to peer with the other peer device(s) for noise cancellation as described herein. In some examples, authorizing the user's device to pair with another peer device that is currently online may also be used as future authorization to pair with still other peer devices that come online at a later time if the other peer device that is being paired with the user's device is itself already paired to communicate with those other devices that come online later.

It may now be appreciated that a dynamic peer network may be formed, e.g., based on similar device capabilities. One peer device may then be elected based on distance to the sound source using sound time of flight. The election of the peer may in some embodiments be unanimous in order for that peer to elected, while in other embodiments only a threshold percentage of devices electing the peer may be used (e.g., seventy five percent). The elected peer(s) may then be used to generate anti-waves and broadcast them on the network. Generation of the anti-wave sounds may be based on initial time of flight information and the sound sources themselves.

Additionally, note that in some situations a business or enterprise may purchase active noise control/cancelling headphones in bulk and so those devices may already have similar device capabilities to work with each other to undertake present principles.

Furthermore, sometimes each set of noise cancelling headphones may be purchased with a base station for charging the headphones. It is to therefore be understood that one or more of the hardware components described herein may be embodied in the base station rather than the headphones themselves. For example, a DSP that is used may be located in the base station. It is to be further understood that certain logic steps or other operations described herein may be executed by a processor in the base station and that communications may be transmitted to other peer devices by the base station rather than the headphones themselves.

It may now be appreciated that present principles provide for an improved computer-based user interface that improves the functionality of the devices disclosed herein in order to more effectively perform noise cancellation. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A first device, comprising:
at least one processor;
a microphone accessible to the at least one processor; and
storage accessible to the at least one processor and comprising instructions executable by the at least one processor to:
present a graphical user interface (GUI) on a display accessible to the at least one processor, the GUI being usable to configure one or more settings of the first device, the GUI comprising an option that is selectable to set the first device to:
detect a first discrete sound based on input from the microphone;
identify a first time at which the input from the microphone is received;
receive an indication from a second device, the indication indicating a second time at which the first discrete sound was detected by the second device;
determine which of the first time and the second time is earlier;
based on the first time being earlier than the second time, select the first device for performance of noise cancellation and transmit noise cancellation signals to the second device based on additional discrete sounds that are detected by the first device; and
based on the second time being earlier than the first time, select the second device for performance of noise cancellation and receive noise cancellation signals from the second device based on additional discrete sounds that are detected by the second device.

2. The first device of claim 1, wherein the instructions are executable by the at least one processor to:
determine that the first time is earlier than the second time; and
transmit, to the second device and based on the determination that the first time is earlier than the second time, respective noise cancellation signals generated based on respective additional discrete sounds that are detected by the at least one microphone on the first device.

3. The first device of claim 2, wherein the instructions are executable to:
determine, based on the first and second times, an offset for respective times at which the same discrete sound reaches the first and second devices; and
transmit, to the second device and based on the offset, one or more indications regarding respective times at which respective audio generated from respective noise cancellation signals received from the first device should be presented at the second device to cancel respective discrete sounds that reach the second device.

4. The first device of claim 2, comprising a digital signal processor (DSP), wherein the respective noise cancellation signals are generated using the DSP prior to transmission of the respective noise cancellation signals to the second device.

5. The first device of claim 1, wherein the instructions are executable by the at least one processor to:
determine that the second time is earlier than the first time; and
receive, from the second device and based on the determination that the second time is earlier than the first time, respective noise cancellation signals generated based on respective additional discrete sounds that are detected by at least one microphone on the second device.

6. The first device of claim 5, wherein the instructions are executable to:
determine, based on the first and second times, an offset for respective times at which the same discrete sound reaches the first and second devices; and
use the offset to present, using the first device and based on receipt of one or more indications from the second device of respective times that respective discrete sounds reached the second device, respective audio generated from the respective noise cancellation signals to cancel the respective discrete sounds as the respective discrete sounds reach the first device.

7. The first device of claim 6, comprising at least one speaker accessible to the at least one processor, and wherein the instructions are executable to:
present, via the at least one speaker, the respective audio generated from the respective noise cancellation signals.

8. The first device of claim 6, comprising a digital signal processor (DSP), wherein the respective audio is presented at least in part by processing the respective noise cancellation signals using the DSP.

9. (canceled)

10. A method, comprising:
establishing a peer to peer network between at least first and second devices;
electing one of the first and second devices for generating noise cancellation signals based on which of the first and second devices is closest to a source of sound;
using the elected device to generate the noise cancellation signals based on sound detected by the elected device; and
transmitting the noise cancellation signals over the peer to peer network to the non-elected device;
wherein the electing, using, and transmitting steps are executed for plural instances of noise cancellation based on selection of an option from a settings graphical user interface (GUI) presented on a display.

11-14. (canceled)

15. The method of claim 10, wherein the method comprises:
determining which of the first and second devices is closest to a source of sound based on which of the first and second devices is the first one to detect a first discrete sound from the source.

16. The method of claim 10, wherein the method comprises:
electing the first device for generating noise cancellation signals based on the first device being closest to the source of sound;
using the first device to generate noise cancellation signals based on sound detected by the first device; and
transmitting the noise cancellation signals peer to peer to the second device.

17. The method of claim 16, wherein the method comprises:
using the first device to facilitate a telephone call;
using the first device to provide, to another device, input to a microphone as part of the telephone call; and
also using the input to the microphone to generate the noise cancellation signals.

18. At least one computer readable storage medium (CRSM) that is not a transitory signal, the computer readable storage medium comprising instructions executable by at least one processor to:
present a graphical user interface (GUI) on a display accessible to the at least one processor, the GUI being usable to configure one or more settings related to noise cancellation, the GUI comprising an option that is selectable to set the at least one processor to in the future, for plural future instances, select a given device to generate noise cancellation signals and transmit the signals over a network;
in a first instance and based on the option being selected from the GUI, select a first device to generate first noise cancellation signals based on the first device being closer to a first source of sound than a second device, the first and second devices communicating with each other over a network;
in the first instance and based on the option being selected from the GUI, use the first device to generate the first noise cancellation signals based on sound from the first source of sound; and
in the first instance and based on the option being selected from the GUI, transmit the first noise cancellation signals over the network to the second device.

19-20. (canceled)

21. The first device of claim 1, wherein the GUI comprises a selector different from the option, the selector being selectable to initiate a process for pairing the first device with one or more other devices for noise cancellation signal exchange.

22. The first device of claim 21, wherein the selector is selectable to begin a process where one or more other devices are discovered and a user provides authorization for the first device to communicate with the one or more other devices for noise cancellation signal exchange.

23. The first device of claim 22, wherein authorization of the first device, for noise cancellation signal exchange according to the process, to communicate with a second device that is currently online is also used as authorization for the first device to in the future communicate with still other devices, for noise cancellation signal exchange, that come online at a later time.

24. The first device of claim 23, wherein authorization for the first device to in the future communicate with still other devices that come online at a later time is performed if the still other devices are already authorized to communicate with the second device for noise cancellation signal exchange.

25. The method of claim 10, wherein the GUI comprises a selector different from the option, the selector being selectable to initiate a process for pairing the first device and/or the second device with one or more other devices for noise cancellation signal exchange.

26. The method of claim 25, wherein the selector is selectable to begin a process where one or more other devices are discovered and a user provides authorization for the first device and/or second device to communicate with the one or more other devices for noise cancellation signal exchange.

27. The CRSM of claim 18, wherein the GUI comprises a selector different from the option, the selector being selectable to initiate a process for pairing devices for noise cancellation signal exchange.
